(19) United States
(12) Patent Application Publication
(10) Pub. No.: US 2011/0314036 A1
(43) Pub. Date: Dec. 22, 2011

(54) SYSTEM FOR CONVERSION OF DATA ITEM ATTRIBUTES

(76) Inventor: William Farrell Cunningham, Minneapolis, MN (US)

(21) Appl. No.: 13/165,186

(22) Filed: Jun. 21, 2011

Related U.S. Application Data
(60) Provisional application No. 61/356,954, filed on Jun. 21, 2010.

(51) Int. Cl. G06F 17/30

(52) U.S. Cl. 707/756; 707/E17.005

(57) ABSTRACT

System and methods may include storing one or more data item entries with one or more attributes fields associated with attributes of a digital content item as well as one or more rule entries with a transformation to apply to an attribute of a digital content item. Further, identification information associated with a user may be received that is associated with a data item that stores data representing a non-monetary balance of the user and a client program. Also, a rule entry may be retrieved based on the identification information and accessing a set of data item entries based on the identification information, the set of data item entries are associated with a set of digital content items. An attribute of the set of digital content items may be transformed into a transformed attribute according to the rule entry based on the identification information.

### CROSS-REFERENCE TO RELATED PATENT DOCUMENTS

This patent application claims the benefit of priority, under 35 U.S.C. Section 119(e), to U.S. Provisional Patent Application Ser. No. 61/356,954 entitled “SYSTEM FOR CONVERSION OF DATA ITEM ATTRIBUTES,” filed on Jun. 21, 2010 (Attorney Docket No.3128.001PRV), which is incorporated by reference in its entirety.

### BACKGROUND

Electronic catalogs allow users to browse through a collection of items and purchase them over the Internet and have them delivered to their homes. Loyalty and reward programs enable a user to purchase goods or services using their points or accrued frequent flyer miles in place of traditional currency.

### BRIEF DESCRIPTION OF THE DRAWINGS

Some embodiments are illustrated by way of example and not limitation in the figures of the accompanying drawings in which:

FIG. 1 diagrams an example component architecture, according to an example embodiment;

FIG. 2 is a sequence diagram of purchasing content, according to an example embodiment;

FIG. 3 diagrams an example component architecture, according to an example embodiment;

FIG. 4 diagrams a method for redemption of digital content, according to an example embodiment;

FIG. 5 diagrams an example transformation of digital contents value;

FIG. 6 diagrams an method of fulfilling a request for digital content, according to an example embodiment; and

FIG. 7 illustrates a computer system, according to an example embodiment.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are illustrated in enough detail to enable those skilled in the art to practice the invention. The embodiments may be combined, other embodiments may be utilized, or structural, logical, and electrical changes may be made without departing from the scope of the present invention. The following detailed description is, therefore, not to be taken in a limiting sense, and the scope of the present invention is defined by the appended claims and their equivalents. In this document, the terms “a” or “an” are used, as is common in patent documents, to include one or more than one. In this document, the term “or” is used to refer to a nonexclusive or, unless otherwise indicated

Network based e-commerce has enabled users to shop from the convenience of network enabled devices (e.g., personal computers, laptops, mobile phones). Many types of items that are sold online relate to physical goods which, after purchase, are delivered to the purchaser's home or place of business. In various embodiments, the items are represented as data items that are stored in one or more databases (e.g., an item database). In an embodiment, data items are displayed on a display device (e.g., a computer or mobile display) with one or more attributes which relate to the real world version of the item. These attributes may include, but are not limited to, a title of the item, a description of the item, a language of the description, a price of the item, and a pictographic representation of the item. Thus, in one example, an e-commerce website sells music albums which are stored as data items in a database with attributes of album title, price of the album, cover art, and track listing.

E-commerce sites have expanded beyond physical goods and began to include digital goods. These goods include, but are not limited to, video games, books, TV shows, movies, music, and general software. In place of a traditional delivery method, an electronic delivery method is used. For example, once a user has purchased a movie, the user may be asked to (or it may be done automatically) activate a hypertext link to enable the download of the movie. For both digital and physical goods, monetary currency may be used as a type of payment in exchange for the goods.

In various embodiments, loyalty and reward programs issue non-monetary currency to participants of the program. For example, a business may belong to a rewards program whose employees are issued reward points for meeting certain performance goals. In order to redeem the non-monetary currency for goods or services, an employee will browse through a rewards catalog (online or print) and order an item using the non-monetary currency. In various embodiments, the goods are delivered to a person's home or place of business.

Currently a disconnect exists in the inventive and rewards business. The value of a dollar is a widely accepted and understood value around the world, but a point value (or other non-monetary currency that a reward program administrator uses to identify a unit) is largely set by a reward program administrators and its clients and is mostly kept secret from the public including the program participants. Program administrators might have hundreds of clients and programs all with different values to their “points.” One solution is to have software which takes the electronic information from content providers and allow the reward program administrators to set the point value of the individual digital files in our secure administration.

Additionally, the software may help merge the familiarity of traditional e-commerce sites that use monetary currency and contain downloadable content for purchase, with the use of non-monetary currency of reward/loyalty programs. In various embodiments, users use shopping websites which allow them to download digital content (songs, etc.) and pay with traditional monetary currency. However, the users may wish to pay with their non-monetary currency in place of, or in additional to, monetary currency. Thus, what is needed is a system to transform the price attribute of a content item from a monetary currency to a non-monetary currency based on the user currently viewing a website of digital content, and with little to no changes made from either the content provider of the digital content or loyal/reward program administrator.

In an example embodiment, a transformation logic is used to act as an interpreter between a content provider (the provider of the downloadable content) and a rewards program/platform administrator to facilitate purchases using non-monetary currency. In an example use case, which will be used throughout, a user or program participant logs into a rewards website which transfers the user to a shopping web application that includes a list of music available for purchase. In various embodiments the shopping web application is hosted by the reward program platform. In yet another example embodiment, the transformation logic may be part of the shopping web application or part of the reward program platform. Thus, in an example embodiment, a digital catalog is created that includes content items with transformed attributes.

In various embodiments, a web application includes one or more webpages stored on a web server that are transmitted over a network and displayed on a display device of a user. The user interacts with the web application using one or more input devices (e.g., a touch screen, keyboard, or mouse). The interactions may be transmitted as indicia indicating the interaction of the user. Based on the user's interactions the user may purchase one or more of the pieces of music. The pieces of music may be stored in a different location than the web server. The web server may store representations of the music as data objects (also referred to as a data items herein) stored in a database. In an embodiment, the data object includes attributes of the music. For example, it may include an identification number, a title, and a price attribute. While the use of music is illustrated, any type of digital downloadable content may be used, including, but not limited to, books, TV shows, movies, music, and general application software. In various embodiments, a data item for sale may be for the right to access one or more pieces of digital content. For example, an external website may offer access to streaming music or for renting games. In an example embodiment, upon purchase of the data item, a user will have access to stream a particular song or album. In another example embodiment, the data item is a one month subscription to an external website which streams music or movies or an external website which hosts personal files (e.g., a cloud service).

In an embodiment, the purchase price attribute of the music has been transformed from monetary currency to non-monetary currency based on the user's loyalty/reward program. In an embodiment, the transformation is based on a rule stored in a database. A rule may be a data object which includes a conversion ratio from the monetary currency to non-monetary currency. The conversion ratio may be set and adjusted at any time by an administrator. In various embodiments, there are rule data objects for each content provider and rule data objects for each client program stored in a rules database. While this use case transforms the price attribute of music, other transformations may also be made to other attributes such as language, description, etc., based on rules stored in the database. Accordingly, in an example embodiment, a digital catalog of music is generated with transformed price attributes.

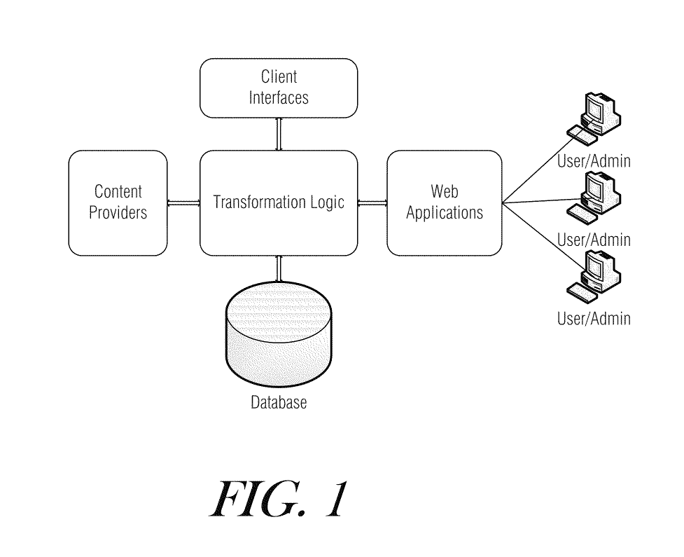

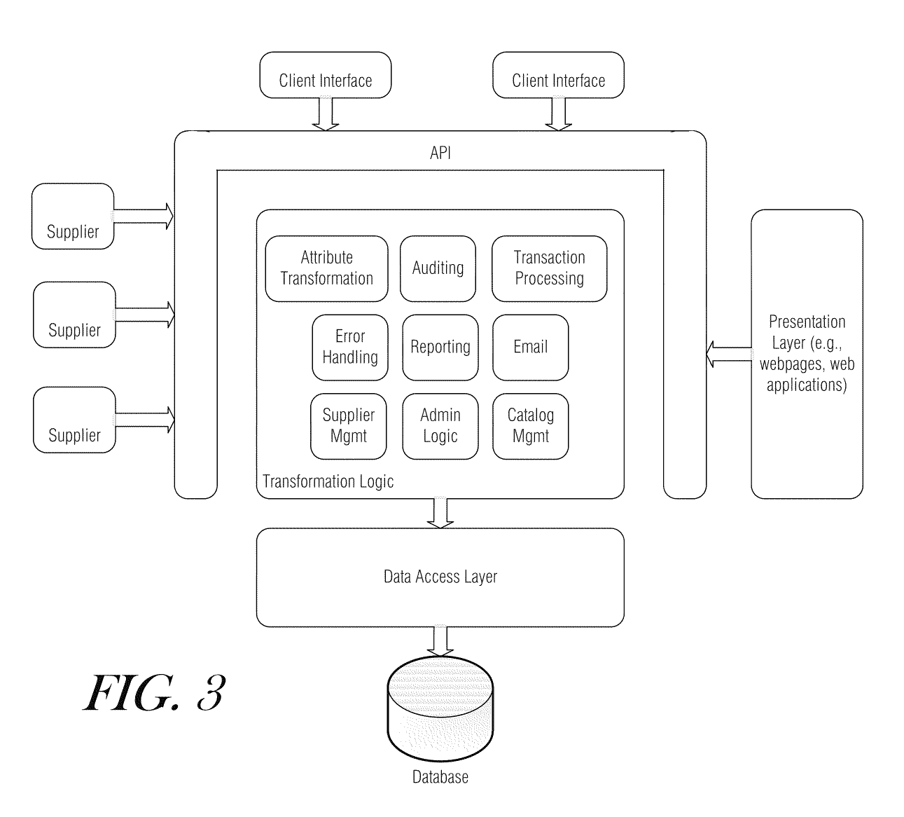

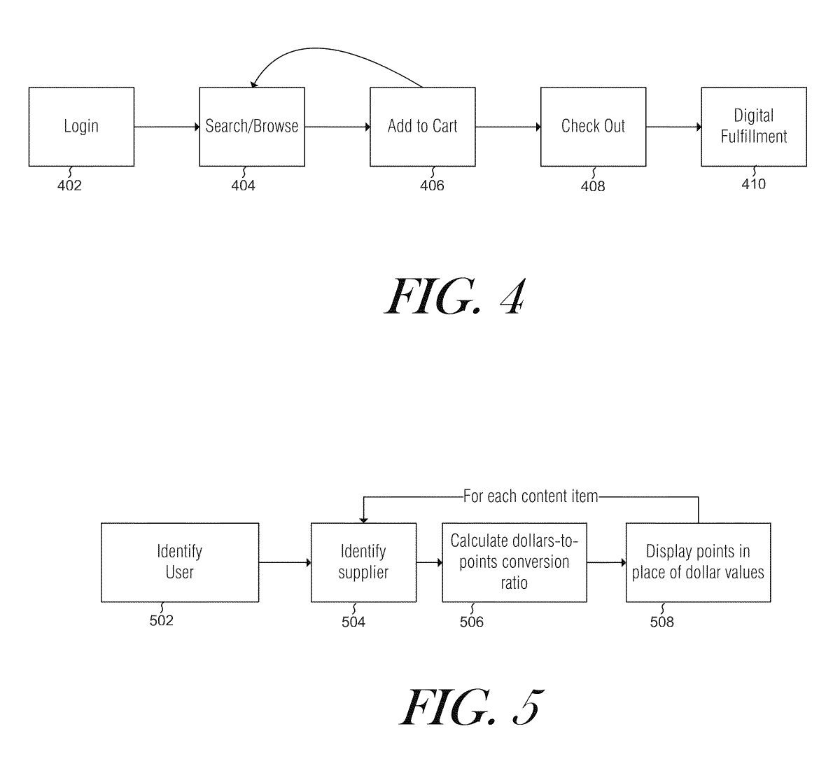

FIG. 1 diagrams an example high-level component architecture of the present subject matter. Illustrated are client interfaces, content providers, transformation logic, web applications, databases, users, and administrators. In an embodiment, clients are those companies which control the loyalty/reward programs. Thus, a client interface provides the information exchanges regarding point balances of existing participants in the loyalty/reward program as well as what content is available for purchase by the participants. The rest of this document will consider the use of a rewards program for convenience. In various embodiments, there are end users that belong to a rewards program and are purchasing digital content of the content providers through one of more web shopping applications. One or more databases store data items representing the digital content items and their attributes which are transformed in accordance with the client program of the end users (e.g., their reward program). Web applications may also be provided for administrators of the transformation logic. The administrators may filter content from content providers as well as change the presentation of a webpage to an end user. A more detailed view of an example component architecture is depicted in FIG. 3.

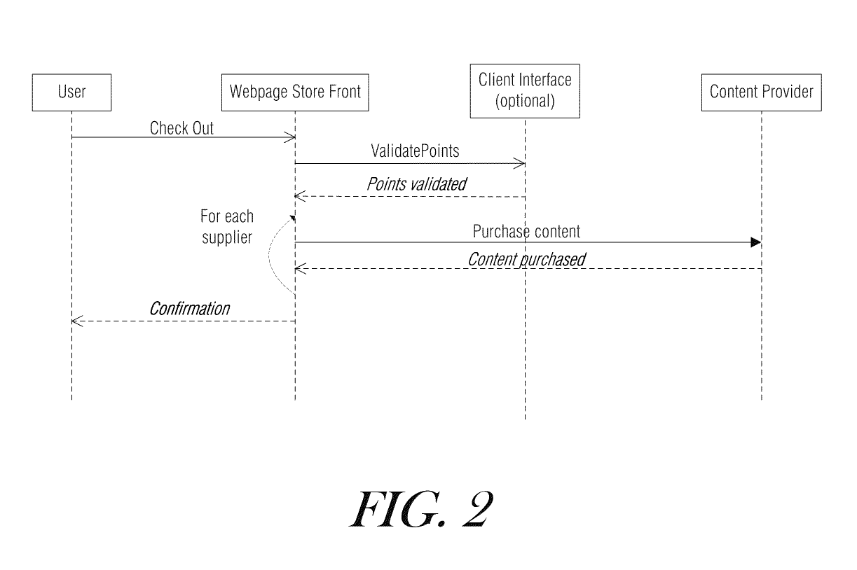

FIG. 2 is a sequence diagram of purchasing content, according to an example embodiment. Illustrated is a sequence of a user purchasing content after one or more pieces of digital content have been added to the user's electronic shopping cart.

In an embodiment, a user is able to select more or more pieces of digital content (e.g., from a digital catalog) from a content provider and add them to an electronic shopping cart via a shopping web application. For example, a user may click on a link next to a representation of a piece of digital content (e.g., an add to cart link is placed next to a picture of an album cover) that adds a representation of the digital content to the electronic shopping cart. In an embodiment, the identification of the selected digital content is stored in a shopping cart data object. The identification may be determined according to the data item stored in a database that represents the digital content. The user will activate a user input control which indicates the user wishes to proceed to purchasing the selected digital content. For example, an input button may be presented on a webpage which presents a checkout interface to the user.

In an embodiment, upon receiving an indication the user is checking out, the web server hosting the shopping web application transmits a request using a client interface to validate that the user has enough points in his or her rewards account to purchase the content. Upon verification, a points verification confirmation is transmitted back to the shopping web application. In various embodiments, the verification is done by the shopping web application instead of sending a separate request to the client interface. For example, a user's point total may be received by the shopping web application upon the user logging into the web application.

In an embodiment, for each piece of digital content the user has added to the electronic shopping cart, a purchase content request is transmitted to the content provider (e.g., a web server) of that piece of digital content. The content provider fulfills the purchase content request by sending a content purchase indication back to the shopping web application. The shopping web application presents a confirmation to the user that the digital content was purchased. In addition to the confirmation, a download link with instruction may be displayed or e-mailed to the user which enables the downloading of the digital content.

FIG. 3 diagrams an example detailed level component architecture of the present subject matter. Illustrated are suppliers (e.g., sources of digital content or content providers), client interfaces, a presentation layer, a data access layer, a database, transformation logic, and an application layer interface (API). In an example embodiment the API provides functionality for the exchange of data between the components of the system. For example, an API call allows suppliers to enter information into the database or be loaded into the database.

In an example embodiment, client interfaces provide a current point balance for those clients who are considered the source of truth for points. A client may be the administrator of a rewards program. This interface also allows for updates after a purchase. For instances when the client is the source of truth (e.g., master record) of an existing users points, the component architecture will integrate with the client through an interface which allows real-time status and updates to those points.

In an example embodiment, the presentation layer includes all of the code necessary to present a series of web interfaces. The web interfaces include web applications for the various users of the system. For example, there may be the shopping web application that facilitates users purchases of user content. There may also be a web application provided to content providers which allows the content provider control over attributes of the digital content (e.g., cover art, purchase price). There may also be an administrator web application which allows an administrator to control the transformation logic of the system. For example, the administrator web application may allow filtering of certain types of content. In various embodiments, the web applications are hosted on different web servers. In various embodiments, the web application are hosted on the same web sever.

In an embodiment, the transformation logic includes the code needed to implement the transformation system. The transformation logic may include one or more additional sub-components. For example, FIG. 3 illustrates sub-components of attribute transformation, auditing, transaction processing, error handling, reporting, e-mail, supplier management, administrator logic, and catalog management. In various embodiments, the sub-components are distributed across one or more web applications. In an embodiment, the data access layer provides functionality for accessing and updating persisted data in the database. This data may include, but is not limited to, digital content attributes, transaction histories, client setup information, and auditing information.

In various embodiments, attribute transformation includes changing the cash value into points and/or manipulating the data to present it in a different way. Auditing includes having the ability to match up the transactions with the cash to point transactions. Error handling includes if errors occur the system will alert all parties involved. Reporting includes the ability to report to the Client what is being purchased and the ability to report what the content provider has sold. E-mail includes keeping users email address and other user data in the admin. Supplier management includes the ability to switch on and off content from certain providers on a client by client basis. Administrator logic includes the software that runs the system and makes the changes to the digital content and provides the administration ability to the client. Catalog management includes adjusting content from suppliers. For example the ability to remove explicit content for some clients.

FIG. 4 diagrams a method for redemption of digital content, according to an example embodiment. At block 402, a user logs into a web application for redeeming reward points. In an embodiment, the user inputs identification information into a rewards web application. The credential information may include a user name, a password, and an identification of the user's reward program.

At block 404, the user searches and browses for digital content. For example, there may be more than one supplier of digital content, but the digital content is presented in a unified list. In an embodiment, music, video, electronic books, apps and software is available for purchase by the user. In various embodiments, access to digital content is available for purchase. For example, in place of paying to download a song, a user may be paying for the rights to stream the song. Similarly, digital content may include the right to use online software. At block 406, a user finds digital content they wish to purchase and adds it to an electronic shopping cart. At block 408, the user checks outs by redeeming available reward points in exchange for the digital content. At block 410, the digital content is retrieved by the user.

FIG. 5 diagrams an example transformation of digital contents value. In order for a user to know if he or she has the available reward points to purchase a piece of digital content, he or she must know how much a piece of digital content costs in reward points. As there are many types of reward programs and many content providers, there are many conversion rates that may apply. In order to facilitate this conversion, the transformation sub-component may transform the price attribute of a digital content item from monetary currency into a non-monetary currency (e.g., the non-monetary cost). In an embodiment, the transformation is based on a rule data object stored in a database.

At block 502, based on login information, the user is identified and their associated company/group is identified as well. For example, using the supplied identification information a lookup may be made into a database to retrieve a user profile. The user profile may include information such as e-mail address, user identification number, reward programs, point balance, and purchase history.

At block 504, for each piece of digital content, the supplier (e.g., content provider) is identified. As multiple suppliers may be used in a shopping web application, different rules may apply to each supplier. At block 506, based on the company/group and content supplier, a dollars-to-points conversion ratio is determined. For example, the rule for what points conversion ratio to use may be retrieved for each content supplier. At block 508, each content item's dollar amount is transformed into points by multiplying the dollar amount by the point conversion ratio stored in the rule. In an example embodiment, a representation of the digital content with its transformed dollar value is displayed to the user.

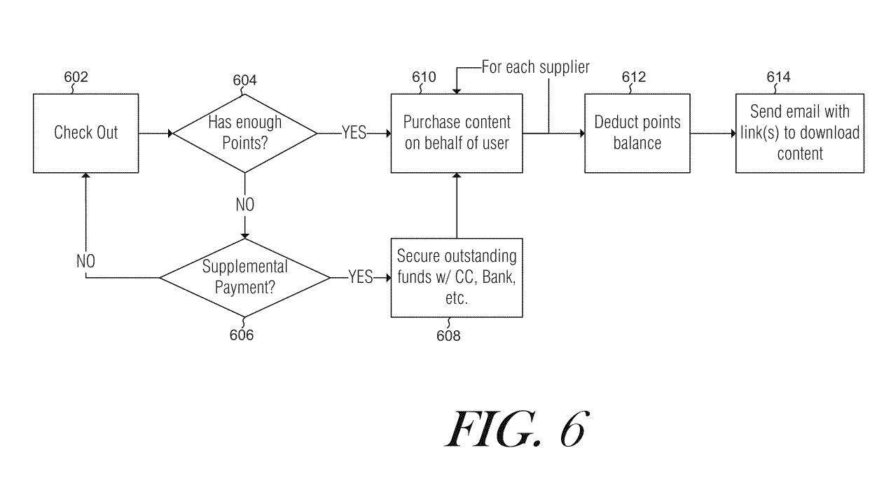

FIG. 6 diagrams a method of fulfilling a request for digital content, according to an example embodiment. At block 602, the user decides to checkout. At decision block 604, it is determined if the user has enough points/miles/credits to cover (e.g., to make the transaction) the costs of the digital content in the electronic shopping cart. If the user does not, at decision block 606, a request may be made to the user for additional payment (e.g., a credit card, check card, etc). At block 608, the additional payment is secured. If no additional funds are secured, control returns back to block 602 where a user may remove digital content items from his or her electronic shopping cart.

At block 610, for each supplier of digital content, the content is purchased on behalf of the user. For example, instead of a user purchasing the digital content directly from the supplier, the shopping web application will transmit data to purchase it on behalf of the user. In this manner, multiple suppliers may be used without the user needing to checkout multiple times (e.g., once for each supplier).

At block 612, the requisite points required to purchase the digital content in the shopping cart are deducted from the user's point balance. In an example embodiment, the client interface is used to deduct the point balance directly (e.g., send a request to decrement the point balance). In a further embodiment, the shopping web application decrements the point balance of the user stored in the user profile. At block 614, either an email is sent to the user's email address which contains one or more links to download the content along with associated instructions or a link is generated immediately without the need to for an email to be sent. This email address may be supplied by the user during checkout or it may be accessed from the database (e.g., the email address may be stored in the user profile). In an embodiment where access is granted to digital content an authorization information may be transmitted to the user enabling the use of the digital content. In an embodiment the supplier of the digital content is notified that the user has been granted access to the digital content.

### A Computer System

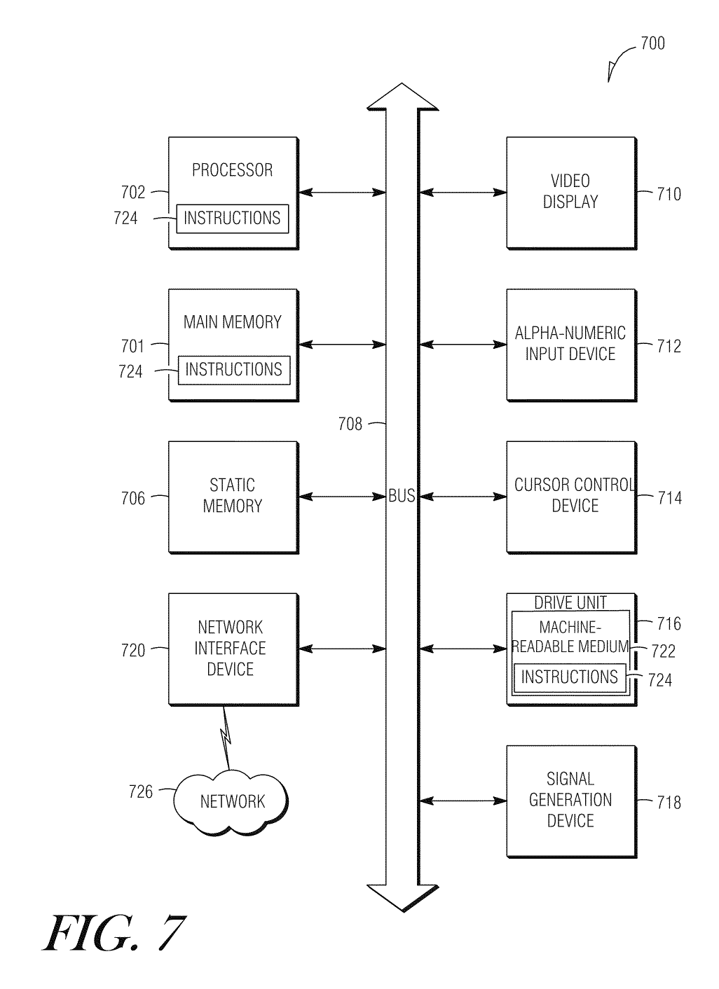

FIG. 7 shows a diagrammatic representation of a machine in the example form of a computer system 700 within which a set of instructions for causing the machine to perform any one or more of the methods, processes, operations, or methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a Personal Computer (PC), a tablet PC, a Set-Top Box (STB), a Personal Digital Assistant (PDA), a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems that are linked (e.g., either by hardwired, wireless, or a combination of hardwired and wireless connections) through a network, both perform tasks. In a distributed system environment, program modules may be located in both local and remote memory-storage devices (see below).

The example computer system 700 includes a processor 702 (e.g., a Central Processing Unit (CPU), a Graphics Processing Unit (GPU) or both), a main memory 701 and a static memory 706, which communicate with each other via a bus 708. The computer system 700 may further include a video display unit 710 (e.g., a Liquid Crystal Display (LCD) or a Cathode Ray Tube (CRT)). The computer system 700 also includes an alphanumeric input device 712 (e.g., a keyboard), a User Interface (UI) cursor controller 714 (e.g., a mouse), a disk drive unit 716, a signal generation device 718 (e.g., a speaker) and a network interface device 720 (e.g., a transmitter).

The disk drive unit 716 includes a machine-readable medium 722 on which is stored one or more sets of instructions 724 and data structures (e.g., software) embodying or used by any one or more of the methodologies or functions illustrated herein. The software may also reside, completely or at least partially, within the main memory 704 and/or within the processor 702 during execution thereof by the computer system 700, the main memory 701 and the processor 702 also constituting machine-readable media.

The instructions 724 may further be transmitted or received over a network 726 via the network interface device 720 using any one of a number of well-known transfer protocols (e.g., HTTP, Session Initiation Protocol (SIP)).

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any of the one or more of the methodologies illustrated herein. The term “machine-readable medium” shall accordingly be taken to include, but not be limited to, solid-state memories, and optical and magnetic medium.

Method embodiments illustrated herein may be computer-implemented. Some embodiments may include computer-readable media encoded with a computer program (e.g., software), which includes instructions operable to cause an electronic device to perform methods of various embodiments. A software implementation (or computer-implemented method) may include microcode, assembly language code, or a higher-level language code, which further may include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, Random Access Memories (RAMs), Read Only Memories (ROMs), and the like.

### Distributed Computing Components

Some example embodiments may include the previously illustrated components (e.g., operations) being implements across a distributed programming environment. For example, operations providing logic functionality may reside on a first computer system that is remotely located from a second computer system containing an Interface or Storage functionality. For example, logic for an administrator web application may reside in a different location than logic for the web application which presents the digital content to the user. These first and second computer systems can be configured in a server-client, peer-to-peer, or some other configuration. These various levels can be written using the above illustrated operation design principles and can be written in the same programming language, or a different programming language.

In some embodiments, the above illustrated operations that make up the platform architecture communicate using the Open Systems Interconnection Basic Reference Model (OSI) or the Transmission Control Protocol/Internet Protocol (TCP/IP) protocol stack models for defining network protocols that facilitate the transmission of data. Applying these models, a system of data transmission between a server and client computer system can be illustrated as a series of roughly five layers comprising as a: physical layer, data link layer, network layer, transport layer and application layer. Some example embodiments may include the various levels (e.g., the Interface, Logic and storage levels) residing on the application layer of the TCP/IP protocol stack. The present application may utilize HTTP to transmit content between the server and client applications (e.g., between a server hosting the web application for a user and user's personal computer), whereas in other embodiments another protocol known in the art is used. Content from an application residing at the application layer is loaded into the data load field of a TCP segment residing at the transport layer. This TCP segment also contains port information for a recipient application or a module residing remotely. This TCP segment is loaded into the data field of an IP datagram residing at the network layer. Next, this IP datagram is loaded into a frame residing at the data link layer. This frame is then encoded at the physical layer and the content transmitted over a network such as the Internet, Local Area Network (LAN) or Wide Area Network (WAN). The term Internet refers to a network of networks. Such networks may use a variety of protocols for exchange of information, such as TCP/IP etc., and may be used within a variety of topologies or structures. This network may include a Carrier Sensing Multiple Access Network (CSMA) such as an Ethernet -based network. This network may include a Code Division Multiple Access (CDMA) network or some other suitable network.

It is to be understood that the above description is intended to be illustrative, and not restrictive. For example, the above-illustrated embodiments (and/or aspects thereof) may be used in combination with each other. Many other embodiments may be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Certain embodiments are described herein as including logic or a number of components, modules, or mechanisms. Modules/logic may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

What is claimed is:

1. A method comprising:
storing, in an item database, one or more data item entries, wherein a data item entry comprises one or more attributes fields associated with attributes of a digital content item;
storing, in a rules database, one or more rule entries, wherein a rule entry comprises a transformation to apply to an attribute of a digital content item;
receiving identification information associated with a user, wherein the identification information of the user is associated with a data item that stores data representing a non-monetary balance of the user and a client program;
retrieving a rule entry based on the identification information and accessing a set of data item entries based on the identification information, wherein the set of data item entries are associated with a set of digital content items;
transforming an attribute of the set of digital content items into a transformed attribute according to the rule entry based on the identification information; and
transmitting to a user's device of the user, digital representations of the set of digital content items with the transformed attribute.

2. The method of claim 1, further comprising:
storing a data item entry in the item database comprising name, description, and dollar value attribute fields.

3. The method of claim 2, further comprising:
storing a first rule entry comprising a transformation to the dollar value attribute field, wherein the transformation to the dollar value attribute field comprises a conversion ratio of dollar value to non-monetary currency, and wherein the conversion ratio is associated with the client program.

4. The method of claim 1, wherein transforming an attribute of a set of digital content items into a transformed attribute according to a rule entry based on the identification information comprises:
multiplying data stored in a dollar value attribute field of a digital content item by a conversion ratio associated with the client program.

5. The method of claim 1, wherein transmitting to the user's device digital representations of the set of digital content items with the transformed attribute comprises:
transmitting a description of a digital content item; and
transmitting a non-monetary cost of the digital content item based on the transformed attribute.

6. The method of claim 5, further comprising:
receiving indicia associated with a user selection of a first digital content item in the set of digital content items; and
comparing the non-monetary balance with a non-monetary cost of the first digital content item.

7. The method of claim 6, further comprising:
transmitting a confirmation of purchase to the user based on the comparing indicating the non-monetary balance is greater or equal to the non-monetary cost; and
transmitting download instructions to the user, wherein the download instructions comprise a download link.

8. A non-transitory machine-readable medium comprising instructions, which when executed by one or more processors, cause the one or more processors to:
store, in an item database, one or more data item entries, wherein a data item entry comprises one or more attributes fields associated with attributes of a digital content item;
store, in a rules database, one or more rule entries, wherein a rule entry comprises a transformation to apply to an attribute of a digital content item;
receive identification information associated with a user, wherein the identification information of the user is associated with a data item that stores data representing a non-monetary balance of the user and a client program;
retrieve a rule entry based on the identification information and accessing a set of data item entries based on the identification information, wherein the set of data item entries are associated with a set of digital content items;
transform an attribute of the set of digital content items into a transformed attribute according to the rule entry based on the identification information; and
transmit to a user's device of the user, digital representations of the set of digital content items with the transformed attribute.

9. The non-transitory machine-readable medium of claim 8, further comprising instructions to cause the one or more processors to:
store a data item entry in the item database comprising name, description, and dollar value attribute fields.

10. The non-transitory machine-readable medium of claim 9, further comprising instructions to cause the one or more processors to:
store a first rule entry comprising a transformation to the dollar value attribute field, wherein the transformation to the dollar value attribute field comprises a conversion ratio of dollar value to non-monetary currency, and wherein the conversion ratio is associated with the client program.

11. The non-transitory machine-readable medium of claim 8, wherein the instructions to cause the one or more processors to transform the attribute of the set of digital content items into the transformed attribute according to the rule entry based on the identification information comprise instructions to cause the one or more processors to:
multiply data stored in a dollar value attribute field of a digital content item by a conversion ratio associated with the client program.

12. The non-transitory machine-readable medium of claim 8, wherein the instructions to cause the one or more processors to transmit to the user's device digital representations of the set of digital content items with the transformed attribute comprise instructions to cause the one or more processors to:
transmit a description of a digital content item; and
transmit a non-monetary cost of the digital content item based on the transformed attribute.

13. The non-transitory machine-readable medium of claim 12, further comprising instructions to cause the one or more processors to:
receive indicia associated with a user selection of a first digital content item in the set of digital content items; and
compare the non-monetary balance with a non-monetary cost of the first digital content item.

14. The non-transitory machine-readable medium of claim 13, further comprising instructions to cause the one or more processors to:
transmit a confirmation of purchase to the user based on the comparing indicating the non-monetary balance is greater or equal to the non-monetary cost; and
transmit download instructions to the user, wherein the download instructions comprise a download link.

15. A system comprising:
an item database storing a data item entry comprising one or more attributes fields associated with attributes of a digital content item;
a rule database storing one or more rule entries, a rule entry comprising a transformation to apply to an attribute of a digital content item; and
a transformation logic configured to:
receive identification information associated with a user, wherein the identification information of the user is associated with a data item that stores data representing a non-monetary balance of the user and a client program;
retrieve a rule entry based on the identification information and accessing a set of data item entries based on the identification information, wherein the set of data item entries are associated with a set of digital content items;
transform an attribute of the set of digital content items into a transformed attribute according to the rule entry based on the identification information; and
transmit to a user's device, digital representations of the set of digital content items with the transformed attribute.

16. The system of claim 15, wherein the item database stores a data item entry comprising name, description, and dollar value attribute fields for a digital content item.

17. The system of claim 16 wherein the rules database stores a first rule entry comprising a transformation to the dollar value attribute field, wherein the transformation to the dollar value attribute field comprises a conversion ratio of dollar value to non-monetary currency, and wherein the conversion ratio is associated with the client program.

18. The system of claim 15, the transformation is further configured to multiply data stored in a dollar value attribute field of a digital content item by a conversion ratio associated with the client program.

19. The system of claim 15, the transformation further configured to:
transmit for display a description of a digital content item; and
transmit for display a non-monetary cost of the digital content item based on the transformed attribute.

20. The system of claim 19, the transformation logic further configured to:
receive indicia associated with a user selection of a first digital content item in the set of digital content items; and
compare the non-monetary balance with a non-monetary cost of the first digital content item.

21. The system claim of claim 20, the transformation logic further configured to:
transmit to the user's device a confirmation of purchase to the user based on the comparing indicating the non-monetary balance is greater or equal to the non-monetary cost; and
transmit to the user's device download instructions to the user, wherein the download instructions comprise a download link.
